(19) United States
(12) Patent Application Publication
(10) Pub. No.: US 2005/0031433 A1
(43) Pub. Date: Feb. 10, 2005

(54) Threaded insert and method of installation

(76) Inventor: Frank Neri, Valencia, CA (US)

Correspondence Address: James M. Duncan;Klein, DeNatale, Goldner, etc., P.O. Box 11172, Balersfield, CA, 93389-1172, US

(21) Appl. No.: 10/635,727

(22) Filed: Aug. 5, 2003

(51) Int. Cl. F16B 37/04

(52) U.S. Cl. 411/180

(57) ABSTRACT

An apparatus and method are described for attaching threaded fasteners to a workpiece, including applications where the workpiece has a first side and a second side, where the second side may be blind. The apparatus is a threaded insert for inserting in a polygonally-shaped hole in a work piece. Upon activation by an installation tool, the radius corners of the insert expand and fill the hole corners providing resistance to spinning in the workpiece. At least one of the sides of the insert has a split extending axially along the side, which increases the load bearing area of the secondary flange formed on the second side.

### BACKGROUND OF THE INVENTION

The present invention relates to an apparatus and method for attaching threaded fasteners to a workpiece, which usually will have a first side, for which access is available, and a second side, which may be a blind side where access is not available. More particularly, this invention relates to a threaded insert having features which increase the pull-out value of the insert, prevent spinning of the insert within the workpiece, and reduce deformation of the host material in thin wall applications.

It is known to use threaded rivet nuts or threaded inserts as anchors for threaded fasteners in a number of different applications, including thin wall applications, such as sheet metal and sheet plastic, which may be too thin to be tapped with threads. In many cases, there is access only to one side of the workpiece, which are known as “blind” applications. In general, the workpiece is drilled or punched and the anchor device is placed within the resulting hole by an installation tool. When the installation tool is activated, a portion of the anchor device on the blind side of the workpiece is deformed to create an enlargement which prevents removing the device from the hole. After the installation tool is removed, a threaded fastener may be inserted into a threaded portion of the device.

It is to be understood that the term “workpiece” as used in this specification refers to any material for which it is desirable to use any of the disclosed embodiments of this device. Typically, the materials for which the threaded insert has the greatest utility are blind applications for thin walled materials such as sheet metal or sheet plastic. Where there is only ready access to one side of a workpiece, it is necessary to employ anchors which may be completely deployed and installed on the visible side of the workpiece. As with other anchoring devices used in blind applications, the threaded insert must have features which retain the device within the workpiece and allow a threaded fastener to be inserted and tightened without the threaded insert spinning or rotating.

In addition, it is often desirable that the workpiece suffer minimal distortion when the threaded insert or fastener is installed to preserve the visual appeal of the workpiece. For example, if the workpiece comprises exposed panels of an automobile, it is desirable that the panels are not visibly deformed by the installation of threaded inserts and the related fasteners. Typically, a portion of the threaded insert on the blind side of the workpiece is plastically deformed into a bubble or secondary flange which is larger than the diameter of the hole in the workpiece, thereby preventing withdrawal of the threaded insert from the hole. However, if the threaded insert is used with thin-walled materials subject to local deformation, the appearance of the workpiece may be damaged if the bubble or secondary flange subjects the material to concentrated loading or point loading as the fastener is tightened. It is therefore desirable that the bubble or secondary flange evenly distribute the load over a relatively large area to minimize such visible alteration.

It is therefore desirable that the anchor device resist spinning or rotating within the hole, that the device be resistant to being pulled from the hole, and that installation of the device causes little or no distortion to the surrounding material of the workpiece.

### SUMMARY OF THE INVENTION

The present invention is directed to a threaded insert which meets the needs identified above.

One embodiment of the disclosed apparatus is a threaded insert for inserting in a hole in a workpiece, where the workpiece has a first side and a second side, where the second side may be a blind side having no available access. The hole in the workpiece has a polygonal cross-section. The threaded insert comprises a first flange for being retained on the first side of the workpiece. The threaded insert further comprises a hollow body, comprising a first section and an axially adjacent second section, the first section comprising a proximal end attached to the first flange and a distal end at which point the first section integrally transitions into the second section. The first section comprises a plurality of sides, the sides extending axially from the proximal end to the distal end, the sides, in cross-section, defining a polygon having the same cross-sectional shape as the hole. The first section is adapted to be inserted through and restrained from rotation by the hole of the workpiece. When installed into the hole, the radius corners of the insert expand and fill the hole corners providing resistance to spinning in the workpiece. At least one side of the first section has a split extending axially along the side. The first section is plastically deformable to form an enlarged portion on the second side of the workpiece to prevent withdrawal of the threaded insert from the hole. The second section has internal threads adapted to receive a threaded fastener.

A method of attaching fasteners to a workpiece having a first side and a second side is also disclosed. One embodiment of the method comprises the steps of punching a hole through the workpiece, the hole having a polygonal cross-section. A threaded insert is attached to an installation tool, where the threaded insert may comprise any of the embodiments of the apparatus disclosed herein, where the sides of the apparatus, in cross-section, define a polygon having the same cross-sectional shape as the hole. The hollow body of the threaded insert is inserted into the hole. The installation tool is activated, creating an enlarged portion of the first section of the threaded insert on the second side. The installation tool is removed and a threaded fastener is inserted into the threads of the threaded insert.

These and other features, aspects, and advantages of the present invention will become better understood with regard to the following description, appended claims, and accompanying drawings.

### BRIEF DESCRIPTION OF THE DRAWINGS

FIG. 1 is a perspective view of an embodiment of the threaded insert.

FIG. 2 is a top view of the embodiment of the threaded insert shown in FIG. 1.

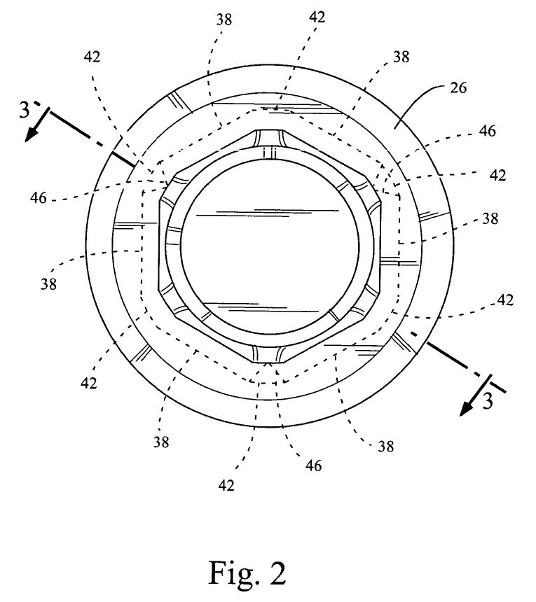

FIG. 3 is a cross-sectional view of the embodiment of the threaded insert shown in FIG. 2.

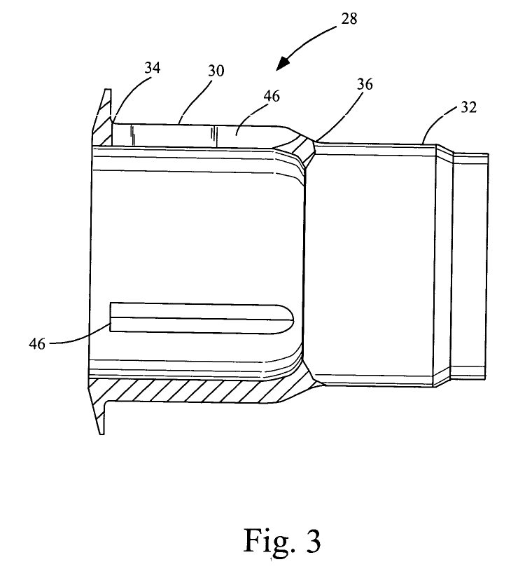

FIG. 4 shows the first side of a workpiece having a hole adapted to receive the embodiment of the threaded insert shown in FIG. 1.

FIG. 5 shows a quarter sectional view of an embodiment of the threaded insert shown in FIG. 1 before being compressed.

FIG. 6 shows a quarter sectional view of an embodiment of the threaded insert shown in FIG. 1 after being compressed.

FIG. 7 is a perspective view of an embodiment of the threaded insert having a sealed end.

FIG. 8 shows a quarter sectional view of the embodiment of the threaded insert shown in FIG. 7 before being compressed.

FIG. 9 shows a quarter sectional view of the embodiment of the threaded insert shown in FIG. 7 after being compressed.

FIG. 10 is a perspective of an embodiment of the threaded insert having a sealing material applied to the underside of the first flange.

FIG. 11 is a side view of one variety of installation tool used for installing a threaded insert into a workpiece.

### DETAILED DESCRIPTION OF THE EMBODIMENTS

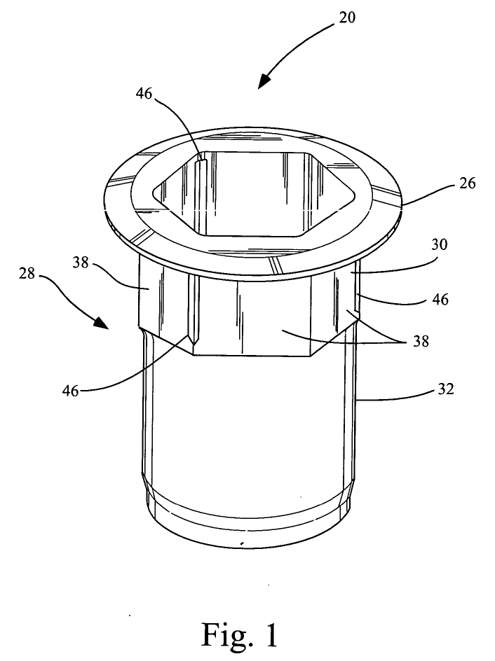

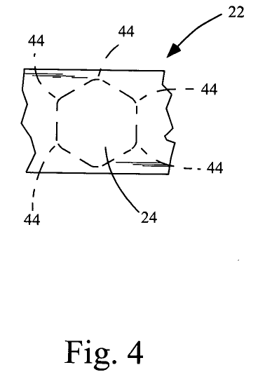

Referring now specifically to the drawings, FIG. 1 shows a perspective view of a first embodiment 20 of the disclosed apparatus, as it appears before installing it within a workpiece, where the workpiece has a hole or bore in the shape of a polygon. For example, the work piece 22 depicted in FIG. 4 has a hexagonal opening 24, although it is to be appreciated that openings having other polygonal shapes may also be used.

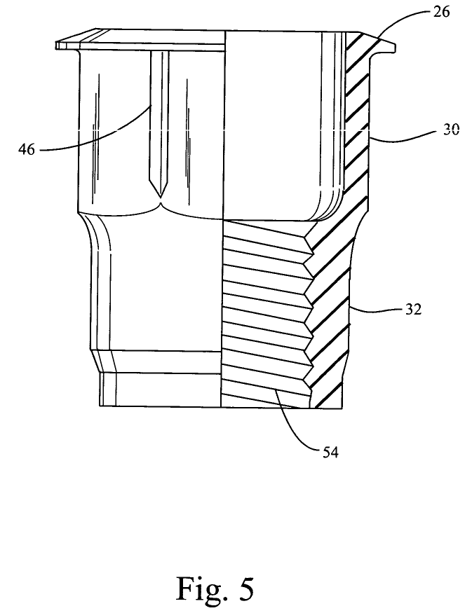

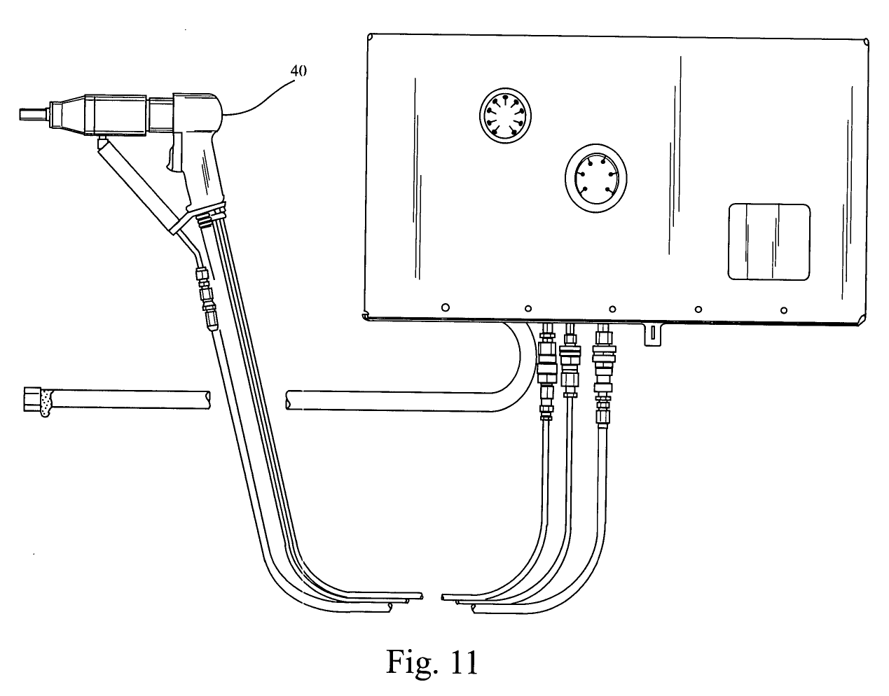

The embodiment 20 of the threaded insert depicted in FIG. 1 comprises a first flange 26 which is retained on the first side 21 of the workpiece 22, the first side being visible, i.e., having available access. This embodiment further comprises a hollow body 28, comprising a first section 30 and an axially adjacent second section 32. The first section 30 comprises a proximal end 34 attached to the first flange 26 and a distal end 36. At the distal end 36, the first section 30 integrally transitions into the second section 32. The first section 30 comprises a plurality of sides 38. The sides 38 extend axially from the proximal end 34 to the distal end 36. In a view taken in cross-section, perpendicular to the longitudinal axis of the hollow body 28, the sides 38 define a polygon having the same cross-sectional shape as the hole or bore in the workpiece 22. Upon activation by an installation tool 40, such as that shown in FIG. 11, the radius corners or vertices 42 of the first section 30 expand and fill the hole corners 44, thereby providing resistance to spinning of the threaded insert in the workpiece 22. During the activation process, the portion of the first section 30 extending outside of the second side 50 is clinched against the second side, causing the metal to flow to lock the insert into position. As shown in FIG. 5, the wall thickness of the first section 30 is less than the wall thickness of the second section 32.

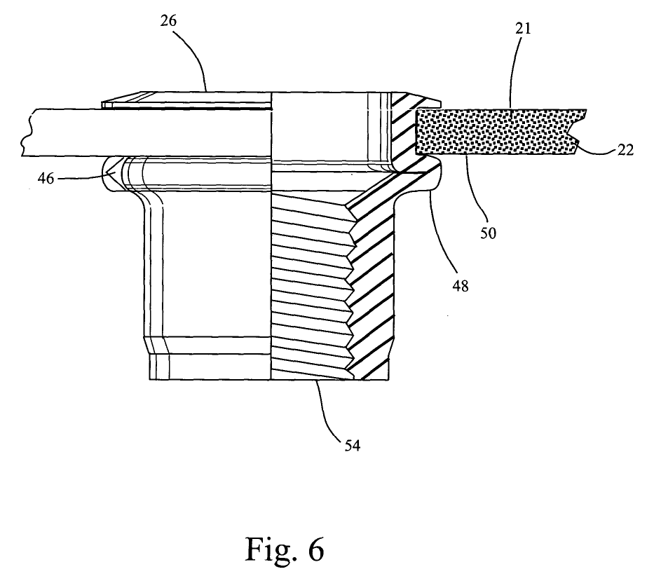

At least one of the sides 38 of the first section 30 has a split 46 extending axially along the side. The split 46 allows for greater spread of the secondary flange 48 or bubble which is formed on the second side 50 of the workpiece 22 upon activation of the threaded insert by an installation tool 40 than would otherwise be obtained without the split 46, resulting in an increase of the load-bearing area of the secondary flange 48. The second side 50 may be a blind side where access is not available. The threaded insert may comprise a plurality of splits 46. For example, an insert having a first section 30 with a hexagonal cross-section may have three splits 46. Moreover, one or more splits 46 may be located along any of the vertices 42 formed where two adjacent sides 38 of the first section 30 intersect. For a hexagon having six vertices and three splits 46, each split may be phased 120 degrees apart. It has been found that this configuration, when activated by an installation tool 40, provides for an acceptable secondary flange 48 for abutting the second side 50 of the workpiece 22. As shown in FIG. 6, upon activation, first flange 26 and secondary flange 48 respectively grip the first side 21 and second side 50 of the workpiece 22, preventing pullout and/or spin of the threaded insert.

At the distal end 36, the first section 30 integrally transitions into the second section 32, the second section generally having a maximum cross-sectional dimension equivalent or less than the maximum cross-sectional dimension of the first section 36. Second section 32 may have a round or circular cross-section. Because the secondary flange 48 is formed by the material comprising first section 30 and not the material of the second section 32, splits 46 do not extend into the second section 32. Second section 32 has internal threads 54 adapted to receive a threaded fastener. The threads may be either unified or metric thread sizes.

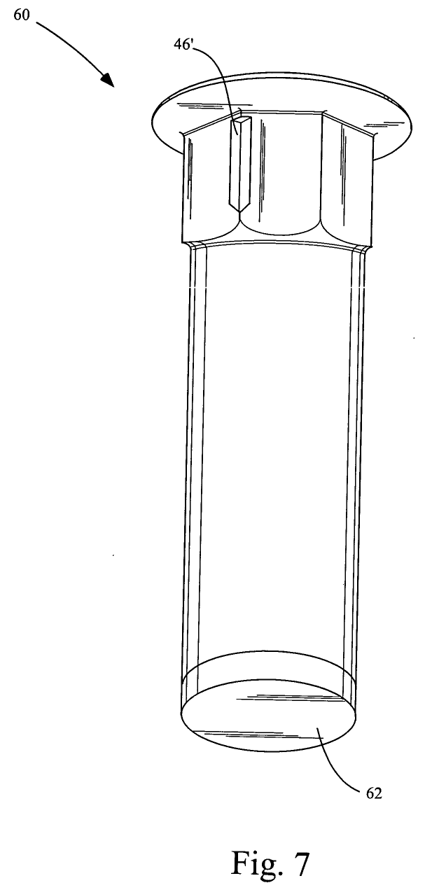

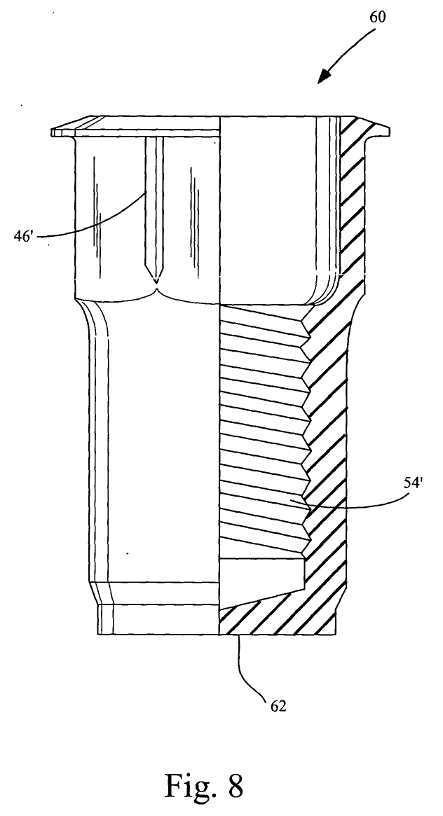

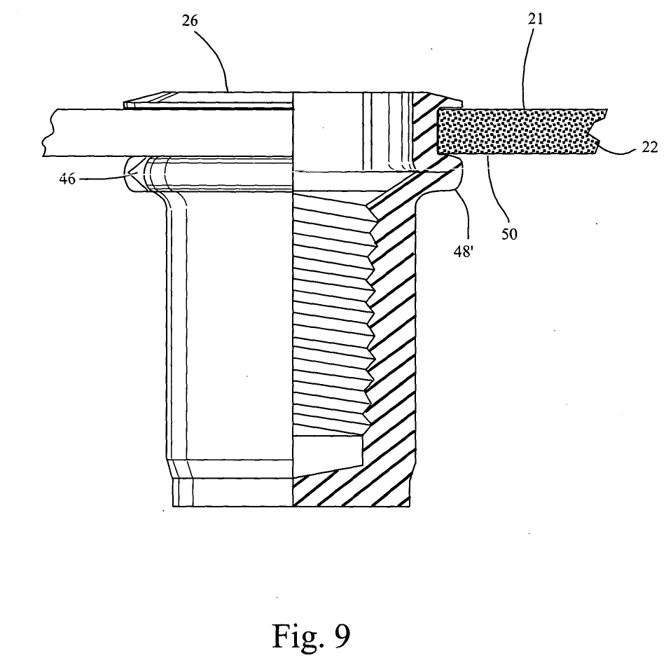

Depending upon the application, a second embodiment 60 of the threaded insert comprises a second section 32′ having a closed end 62, as depicted in FIGS. 7 through 9. FIG. 7 provides a perspective view of the second embodiment 60, while FIG. 8 depicts a quarter sectional view of this embodiment before the secondary flange 48′ is formed. FIG. 9 depicts a quarter sectional view of the second embodiment 60 after the secondary flange 48′ is formed by activation by an installation tool 40.

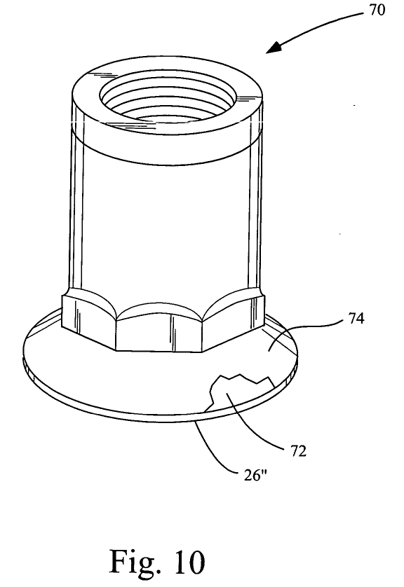

FIG. 10 depicts a third embodiment 70 of the threaded insert wherein the underside 72 of the first flange 26″, which abuts the first side of the workpiece, has a sealing material 74 attached or bonded to the underside. The sealing material 74 may comprise a variety of different materials, including polyvinyl chloride foam.

Depending upon the application, the disclosed threaded insert may be manufactured from a variety of materials, including carbon steel, stainless steel, aluminum, copper, magnesium and titanium, and alloys of each of these. The threaded inserts may comprise a variety of finishes, including zinc/yellow dichromate finish and tin/zinc alloy finish.

It is to be appreciated that while the figures herein depict embodiments suitable for application in hexagonal openings, the disclosed apparatus is not limited to polygons having six sides. An important characteristic of the shape of the first section 30 of the disclosed apparatus is that when a particular embodiment of the device is installed into a hole or bore and activated by an installation tool 40, the radius corners 42 of the first section 30 expand and fill the hole corners providing resistance to spinning of the device in the workpiece. Any polygonal shape having this characteristic is appropriate for the first section 30.

A method of attaching fasteners to a workpiece 22 having a first side 21 and a second side 50 is also disclosed. The method comprises the steps of punching a hole through the workpiece, the hole having a polygonal cross-section. The threaded insert may comprise any of the embodiments 20, 60, 70 of the apparatus disclosed herein, where the sides of the apparatus, in cross-section, define a polygon having the same cross-sectional shape as the hole in the workpiece 22. The threaded insert is attached to an installation tool 40 by screwing the threaded tip of the tool into the internal threads 54 of the threaded insert. The hollow body 28 of the threaded insert is inserted into the hole. The installation tool 40 is activated, reciprocating the tool tip toward the tool and pulling tension on the second section 32 and thereby causing the metal of the first section 30 to flow creating an enlarged portion of the first section on the second side 50 of the workpiece 22. The installation tool 40 is removed and a threaded fastener is inserted into the internal threads 54 of the threaded insert.

The embodiments of the threaded insert disclosed herein may be manufactured by hot or cold forge processes known to those skilled in the art. The threaded insert may be produced from any metal, ferrous or non-ferrous, with any starting shape capable of producing the finished product.

One method of cold forge manufacture of a insert having a hexagonal first section may be generally described as follows. Coiled wire is fed into a horizontal forging machine to produce a cut-off blank having a desired length. The cut-off blank is sized in a first operation where the blank is compressed between a ram and a die pin. In the second operation, the first flange is generally formed when the blank is pushed through a die until the end of the blank engages a die pin. A portion of the blank remains outside of the die, and, as the blank is compressed, material from the outside portion of the blank is forced to flow radially outward, generally forming the flange. In the third operation, a first reverse extrusion pin, having a diameter smaller than the outside diameter of the blank, is pushed into the blank, causing metal to flow around the outside of the first reverse extrusion pin, forging the blank into a tubular shape, generally forming the inside diameter of the first section. In the fourth operation, a second reverse extrusion pin, having a smaller diameter than the first reverse extrusion pin, is pushed into the blank, generally forming the inside diameter of the second section.

In the fifth operation, a hexagonal pierce pin is inserted into the blank, which also pushes the blank through a die having a hexagonal shape approximately half the length of the blank. As the hexagonal pierce pin comes into contact with the blank, the hexagonal portion of the pin forces the interior diameter of the blank outward, imparting a hexagonal shape as the blank conforms to the die. This operation forms a first section on the blank having a hexagonal-shaped exterior and interior. The die also has wedges which form splits 46 in the blank. The wedges are positioned within the die according the desired pattern of the splits 46. For example, if the first section is hexagonal and having six vertices, three splits 46 may be placed within three of the vertices and phased 120 degrees apart by positioning the wedges within the corresponding portions of the die. The resulting insert is thereafter removed from the die and internal threads 54 placed in the second section 32.

It is to be understood that other methods of manufacture in addition to the above-described cold forging manufacturing process known to those skilled in the art might be utilized to manufacture the various embodiments of the threaded insert disclosed herein, including hot forging and machining.

While the above is a description of various embodiments of the present invention, further modifications may be employed without departing from the spirit and scope of the present invention. For example, the size, shape, and/or material of the various components may be changed as desired. Thus the scope of the invention should not be limited by the specific structures disclosed. Instead the true scope of the invention should be determined by the following claims.

1-8 (Canceled)

9. A threaded insert for insertion in a hole in a workpiece, the workpiece having a first side and a second side, the hole having a hexagonal cross-section, said threaded insert comprising:
a first flange for being retained on the first side of the workpiece;
a hollow body, comprising a first section and an axially adjacent second section, the first section having a proximal end attached to the first flange and a distal end wherein the first section integrally transitions into the second section, said first section having six sides, the sides extending axially from the proximal end to the distal end, the sides, in cross-section, defining a hexagon, said first section adapted to be inserted through and restrained from rotation by said hole, wherein at least three vertices of the hexagon each has a split extending axially along the respective vertex wherein the splits are phased 120 degrees apart, said first section plastically deformable to form an enlarged portion on the second side; and
the second section having internal threads adapted to receive a threaded fastener.

10. The insert of claim 9 wherein the second side is blind.

11. The insert of claim 9 wherein the second section is round.

12. The insert of claim 9 wherein the second section has a closed end.

13. The insert of claim 9 wherein a sealing material is affixed to the underside of the first flange adjacent to the first side of the workpiece.

14. The insert of claim wherein the sealing material comprises polyvinyl chloride foam.

15. (Canceled)

16. The insert of claim 9 wherein a split is located along each vertex of the hexagon.

17-19. (Canceled)

20. A threaded insert for insertion in a hole in a workpiece, the workpiece having a first side and a second side, the hole having a hexagonal cross-section, said threaded insert comprising:
a first flange for being retained on the first side of the workpiece;
a hollow body, comprising a first section and an axially adjacent round second section, the first section having a proximal end attached to the first flange and a distal end wherein the first section integrally transitions into the second section, said first section having six sides, the sides extending axially from the proximal end to the distal end, the sides, in cross-section, defining a hexagon, said first section adapted to be inserted through and restrained from rotation by said hole, a split extending axially along each of three vertices of the hexagon, wherein the splits are 120 degrees apart, said first section plastically deformable to form an enlarged portion on the second side; and
the second section having internal threads adapted to receive a threaded fastener.

21. The insert of claim 20 wherein the second side is blind.

22. The insert of claim 20 wherein the second section has a closed end.

23. The insert of claim 20 wherein a sealing material is affixed to the underside of the first flange adjacent to the first side of the workpiece.

24. The insert of claim 23 wherein the sealing material comprises polyvinyl chloride foam.

25. A method of attaching fasteners to a workpiece, the workpiece having a first side and a second side, the method comprising the steps of:
punching a hole through the workpiece, the hole having a polygonal cross-section;
attaching a threaded insert to an installation tool, the threaded insert comprising:
(a) a first flange for being retained on the first side of the workpiece;
(b) a hollow body, comprising a first section and an axially adjacent second section, the first section comprising a proximal end attached to the first flange and a distal end wherein the first section integrally transitions into the second section, said first section comprising a plurality of sides, the sides extending axially from the proximal end to the distal end, the sides, in cross-section, defining a polygon having the same cross-sectional shape as the hole, said first section adapted to be inserted through and restrained from rotation by said hole, at least one of the sides having a split extending axially along the side, said first section plastically deformable to form an enlarged portion on the second side; and
(c) the second section having internal threads adapted to receive a threaded fastener;
inserting the hollow body of the threaded insert into the hole;
activating the installation tool to create an enlarged portion of the first section of the threaded insert on the second side;
removing the installation tool; and
inserting a threaded fastener into the threads of the threaded insert.

26. The method of claim 25 wherein the second side is blind.

27. A method of attaching fasteners to a workpiece, the workpiece having a first side and a second side, the method comprising the steps of:
punching a hole through the workpiece, the hole having a polygonal cross-section;
attaching a threaded insert to an installation tool, the threaded insert comprising:
(a) a first flange for being retained on the first side of the workpiece;
(b) a hollow body, comprising a first section and an axially adjacent second section, the first section having a proximal end attached to the first flange and a distal end wherein the first section integrally transitions into the second section, said first section having six sides, the sides extending axially from the proximal end to the distal end, the sides, in cross-section, defining a hexagon, said first section adapted to be inserted through and restrained from rotation by said hole, at least one of the sides having a split extending axially along the side, said first section plastically deformable to form an enlarged portion on the second side; and
(c) the second section having internal threads adapted to receive a threaded fastener;
inserting the hollow body of the threaded insert into the hole;
activating the installation tool to create an enlarged portion of the first section of the threaded insert on the second side;
removing the installation tool; and
inserting a threaded fastener into the threads of the threaded insert.

28. The method of claim 27 wherein the second side is blind.
